(19) United States
(12) Patent Application Publication
(10) Pub. No.: US 2010/0155677 A1
(43) Pub. Date: Jun. 24, 2010

(54) Polyurethane Roller with Reduced Surface Resistance

(76) Inventors: Bradley Leonard Beach, Lexington, KY (US); Kelly Ann Killeen, Lexington, KY (US); Ronald Lloyd Roe, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/341,350

(22) Filed: Dec. 22, 2008

(51) Int. Cl. H01B 1/06; B28B 1/14

(52) U.S. Cl. 252/521.5; 252/500; 252/518.1; 264/299

(57) ABSTRACT

The present disclosure relates to an image forming component. The component may include a urethane body, comprising polydiene containing a residual double bond available for oxidation, and including a surface, wherein said double bond is oxidized. The component may also include a first conductive additive including an alkali metal salt, wherein the first conductive additive catalyzes the oxidation of the polydiene and a second conductive additive including an inert conductive additive that does not catalyze the polydiene oxidation, wherein the image forming component exhibits a surface resistivity in the range of 1.0×10⁹ to 1.0×10¹² ohm-cm, when characterized at 15.6° C. and 20% RH.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to roller exhibiting a reduced surface resistance, wherein the roller may include a first conductive additive that may oxidize and a second oxidatively inert conductive additive such as quaternary ammonium salts, alkali salts or non-ionic polyoxyalkylene polyols.

2. Description of the Related Art

Many image forming devices, such as printers, copiers, fax machines, or multi-functional machines, utilize toner to form images on media or paper. The image forming apparatus may transfer the toner from a reservoir to the media via a developer system utilizing differential charges generated between the toner particles and the various components in the developer system. In particular, one or more toner adder rolls may be included in the developer system, which may transfer the toner from the reservoir to a developer roller. The developer roll may then apply the toner to a selectively charged photoconductive substrate forming an image thereon, which may then be transferred to the media.

Developer rollers may include one or more layers, having varying resistivity. Two layer rolls, or coated rolls, may develop a fixed quantity of toner per volt of development bias that may be determined by the dielectric thickness of the photoconductor, the toner and the developer roll, independent of speed (within limits). A solid roll having a single resistivity may develop a quantity of toner based on the dielectric constants of the photoconductor and the toner, and the resistance of the roll in the photoconductor nip, which may be dependent on process speed. A two layer roller may have a longer time constant than a single layer roll, which may result in the two layer roller having a higher effective development surface at the entry to the photoconductor nip. This may improve single pel dot print performance of the two layer roll, providing superior performance over the single layer roll across a wide process speed range, being less sensitive to varying environmental conditions.

Producing two layer rolls generally requires a multi step process which increases the cost of the roll and the risk of defect introduction. In preparing two layer rolls one may begin by preparing the core material, which may include forming the core and the secondary steps of providing a desired diameter and surface finish. A coating must then be applied, which may also require the secondary steps of providing a desired thickness and surface finish. Alternatively, it is possible to create a two layer roll from a single urethane core without a separate coating step by using a unique combination of materials, which form a resistive surface layer upon oxidation. However, adjusting the resistivity may be difficult, as the resistivity may be affected by additive concentrations in the material, process time and/or temperatures, and/or oxygen concentration. In addition, adjusting the surface layer resistivity of such an oxidized two layer roll may also effect other roll properties such as core resistivity, hardness and/or compression set. It may be appreciated that it may therefore be desirable to find a more efficient manner of tuning the resistivity of an oxidized two layer roller.

### SUMMARY OF THE INVENTION

An aspect of the present disclosure relates to an image forming component. The image forming component may include a urethane body, comprising a polydiene containing a residual double bond available for oxidation, and including a surface, wherein the double bond is oxidized. The component may also include a first conductive additive including a transition metal salt, wherein the first conductive additive catalyzes the oxidation of the polydiene; and a second conductive additive including an inert conductive additive that does not catalyze the polydiene oxidation. In addition, the image forming component may exhibit a surface resistivity in the range of 1.0×10⁹ to 1.0×10¹² ohm-cm, when characterized at 15.6° C. and 20% RH.

A further aspect of the present disclosure relates to a method of making an image forming component. The method may include mixing a diisocyanate, a diol, a first conductive additive including a transition metal salt and a second conductive additive to form a mixture. The mixture may be formed into a component having a surface. The surface may then be oxidized, wherein the first conductive metal salt catalyzes the oxidation of the diol and the second conductive additive is inert and does not catalyze the oxidation of the diol, to form an image forming component. The image forming component may exhibit a surface layer resistivity in the range of 1.0×10⁹ to 1.0×10¹² ohm-cm, when characterized at 15.6° C. and 20% RH.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side view of a component contemplated herein, wherein the component is a developer roller; and

FIG. 2 is an example of a developer roller present in a cartridge in an image forming device.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The present disclosure relates to a developer roller or other component and the formation of such component for an image forming apparatus that may include varying resistivity of the component at and/or near the component surface. An image forming apparatus or device may be understood as a device that may provide for the formation of an image on a piece or sheet of media. Image forming devices may include, for example, printers, copiers, fax machines, all in one devices, multifunctional devices, etc.

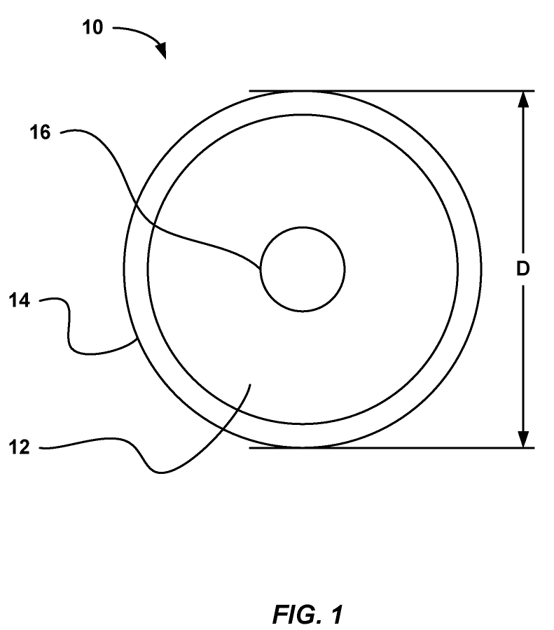

An example of a component is illustrated in FIG. 1. The component 10, a developer roller, may include a core 12 and a resistive layer 14 formed on the core. While the resistive layer is illustrated as a discrete layer, it may be appreciated that the resistive layer 14 may gradually change in resistivity through at least a portion of the diameter D of the roll. For example, a relatively higher resistivity may be exhibited near or at the surface.

The roller may be formed from a cast urethane rubber. The rubber may include a polydiene and urethane prepolymer such as a polyester or polycarprolactone urethane prepolymer. Polydiene may be understood to be comprised of a monomer having a residual carbon double bond (subsequent to polymerization) in the polymer chain. One example of a polydiene may include polybutadiene and/or polyisoprene. The polydiene may include polyol (e.g. 2 or more —OH groups associated with a hydrocarbon) or diisocyanate functionality thereby making them available for incorporation into a segmented polyurethane material.

The polybutadiene prepolymers may be prepared by the reaction of a polybutadiene diol with a diisocyanate such as a toluene diisocyanate (TDI). The prepolymer may be blended with other prepolymers in various proportions. Prepolymer/polybutadiene blend ratios may range from 95/5 to 60/40 parts by weight.

A polydiene diol may be used as well, such as a polybutadiene diol. An example of a polybutadiene diol may include POLY bd® R-45HTLO, available from Sartomer Company, Inc., an α,ω-telechelic polybutadiene diol with a molecular weight, Mn, of approximately 2,800 and a microstructure of 20% cis-1,4-polybutadiene, 60% trans-1,4-polybutadiene and 20% 1,2-vinyl-polybutadiene.

Diisocyanates may include aromatic diisocyanates such as methylene diphenyl diisocyanate or toluene diisocyanate as well as aliphatic diisocyanates (e.g. hexamethylene diisocyanate). One example of a diisocyanate may specifically include toluene diisocyanate. Furthermore, one may utilize prepolymers, such as urethane prepolymers containing end-group isocyanate functionality (e.g. 2 or more —NCO groups). For example, Versathane® A7QM, a polyester based polyurethane prepolymer available from Air Products and Vibrathane® 6060 available from Chemtura Corporation, which is a caprolactone based polyurethane prepolymer can be used.

The rubber may also include a first conductive additive. A conductive additive may be understood to be an additive that may be used to adjust the ability of an object to conduct an electrical current between two points. Conductivity may be understood as the inverse of the electrical resistivity. In one example, the first conductive additive may reduce the electrical resistivity of the roller to <1×10¹⁰ Ohm-cm, when measured at 15.6° C. and 20% relative humidity.

The first conductive additive may be a metal salt that may catalyze the oxidation of polydiene in air at elevated temperatures, of 80° C. or greater, including all values and increments therein, such as 80° C. to 150° C. The metal salts may include metal halides such as ferric chloride, ferrous chloride, ferric bromide and/or calcium chloride. It may be appreciated that one or more of the above may be included in the urethane formulations herein. The first conductive additive may be present in the urethane composition in the range of 0.01% to 1.00% by weight solids of the urethane composition, including all values and increments therein.

The rubber may further include a second conductive additive, which may be relatively inert, i.e., the additive does not participate in or interfere with the oxidation of the polydiene, and in particular oxidation of the polydiene on the surface, which as noted above, may be catalyzed by the first conductive additive. Once again, as noted above, a conductive additive may be understood as an additive that may be used to adjust the ability of an object to conduct an electrical current between two points. The second conductive additive may include an alkali metal salt, such as salts of Li, Na, K and Cs, including, for example, LiPF₆, LiAsF₆, LiClO₄, LiBF₄, LiCF₃SO₃, LiN(SO₂CF₃)₂, LiN(SO₂C₂F₅)₂, LiC(SO₂CF₃)₃, LiPF₃(C₂F₅), lithium bis(oxalato)borate, NaPF₆, KPF₆, and/or Cs(CF₃COCH₂COCF₃) (abbreviated as CsHFAc). An example of LiN(SO₂CF₃)₂ may include FLUORAD HQ-115 available from 3M. The second additive may also include quanternary ammonium salts, such as, for example, Bu₄NPF₆, Bu₄NSO₃CF₃, Bu₄NCl, Bu₄NBr, dimethylethyldodecylammonium ethosulfate. The second additive may also include a non-ionic polyoxyalkylene polyol, which may be cured directly into the polyurethane matrix, such as POLYOL 3165 available from Perstorp Polyols, Inc. It may be appreciated that one or more of the above may be included in the urethane formulations herein. The second conductive additive may be present in the urethane composition in the range of 0.001 to 20.000% by weight solids of the urethane composition, including all values and increments therein.

Furthermore, additional curatives may be added to the rubber. The curatives may be used to modify the physical properties of the urethane elastomer. The curatives may exhibit di-functionality, tri-functionality or greater functionality. The functional groups may include, for example, active hydrogens such as amines or hydroxyls. The curatives may include, for example, polycaprolactone polyols such as CAPA® available from Solvay Caprolactones; polyether diols or thiols such as VORANOL® available from Dow Chemical, POLY-G® or POLY-Q® available from Arch Chemical, Inc., or PLURACOL® available from BASF; polyester diols such as FOMREZ® available from Witco Corp.; and/or polymethyldisiloxane diols or diamines such as SILAPLANE® available from Chisso Corp. In addition, curatives may include Polyol 3611 available from Perstorp Polyols, Inc.—a trifunctional polyether polyol, or triisopropanol amine (TIPA). It may be appreciated that one or more of the above may be included in the urethane formulations herein. Furthermore, the curatives may be present in the range of 0.10% to 20.0% by weight solids of the urethane composition, including all values and increments therein.

An antioxidant may be added to the urethane formulation as well. The antioxidant may include aromatic amines, hindered phenols and/or hydroperoxide decomposers such as phosphate or sulfide. For example, the antioxidant may include a hindered phenol such as 2,6-di-t-butyl-4-methylphenol (BHT).

The urethane formulation may be cast or otherwise formed into a mold around a metal shaft 16, as illustrated in FIG. 1. The metal shaft may be a conductive metal shaft, such as aluminum, copper, steel alloys, etc., as well as filled polymer materials. The shaft may be a solid cylinder or a hollow tube. However, in other components, the urethane formulation may simply be cast or molded into a given shape. The urethane formulation may then be cured at a temperature in the range of 50° C. to 150° C., including all values and increments therein. Once cured or partially cured, the component may then be ground to the required functional dimensions and baked at an elevated temperature of 80° C. or greater in air or an otherwise oxygenated environment to oxidize the surface of the roll.

The resulting component may exhibit a surface layer resistivity in the range of 1.0×10⁹ to 1.0×10¹² ohm-cm, including all values and increments therein, at 15.6° C. and 20% RH (relative humidity). In addition, the resulting component may exhibit a bulk resistivity in the range of 1×10⁷ to 1×10⁹ ohm-cm, including all values and increments therein, at 15.6° C. and 20% RH (relative humidity). Furthermore, the component may exhibit a resistive layer having a thickness of 30 μm to 250 μm, including all values and increments therein. The component may also exhibit a Shore A hardness in the range of 40 to 65, including all values and increments therein, as measured by ASTM D2240-86. The component may exhibit a compression set of in the range of <5.00% of the total thickness of the rubber, as measured by ASTM D395-89, method B, at a compression of 25% at a temperature of 70° C. for 22 hours, wherein the resultant permanent set is measured at room temperature.

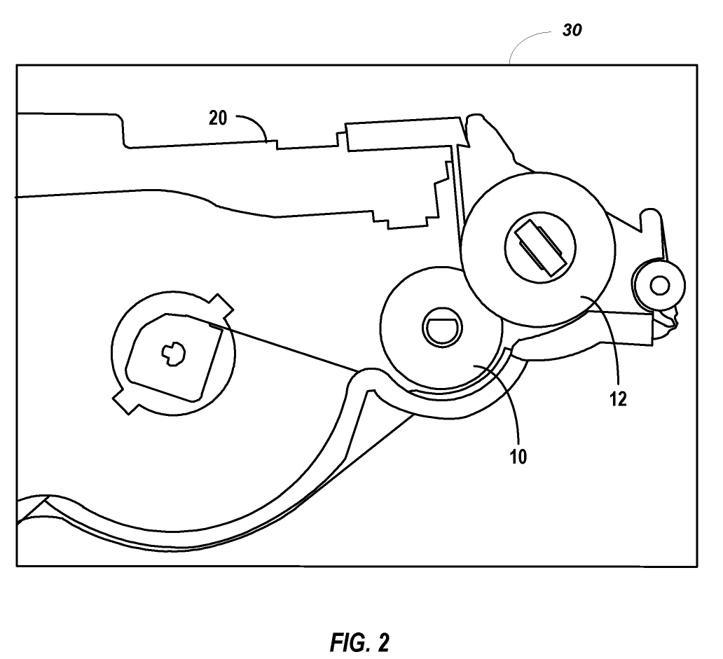

While the application refers to a developer roller, such as 12 in FIG. 2, it may be appreciated that other components may be contemplated herein as well, such as toner adder rollers (see 10 in FIG. 2) or charge rollers, and various other components. Furthermore, the developer roller 12, may be positioned within a cartridge 20, such as a toner cartridge or a photoconductor cartridge as contained and removably positioned within an image forming apparatus 30. The developer roller 12 may pass toner to selectively charged areas of a photoconductive element (not illustrated).

### EXAMPLE

The examples herein are for the purpose of illustrating the components and methods of forming such components described herein and are not meant to limit the scope of the description or claims appended hereto.

### Example 1

A number of urethane elastomers were produced as outlined in Tables 1a and 1b. The ingredient ratios are listed as weight % solids. Example C is a comparative example not containing the second conductive additive.

TABLE 1a

| | Example # | | | | | |
|---|---|---|---|---|---|---|
| | C | 1 | 2 | 3 | 4 | 5 |
| polycarprolactone/ | 82.87 | 82.87 | 82.87 | 82.87 | 82.83 | 82.85 |
| diisocyanate | | | | | | |
| prepolymer | | | | | | |
| polybutadiene + | 12.33 | 12.33 | 12.33 | 12.33 | 12.33 | 12.33 |
| BHT | | | | | | |
| tri-functional | 4.53 | 4.53 | 4.53 | 4.53 | 4.53 | 4.53 |
| curative | | | | | | |
| (POLYOL 3611) | | | | | | |
| TIPA | 0.1 | 0.1 | 0.1 | 0.1 | 0.1 | 0.1 |
| FeCl₃ | 0.17 | 0.17 | 0.17 | 0.17 | 0.17 | 0.17 |
| LiN(SO₂CF₃)₂ | — | 0.005 | 0.003 | 0.002 | — | — |
| CsHFAc | — | — | — | — | 0.05 | 0.033 |
| tri-functional | — | — | — | — | — | — |
| curative | | | | | | |
| (POLYOL 3165) | | | | | | |

TABLE 1b

| | Example # | | | | |
|---|---|---|---|---|---|
| | 6 | 7 | 8 | 9 | 10 |
| polycarprolactone/ | 82.86 | 77.03 | 78.4 | 79.41 | 80.77 |
| diisocyanate | | | | | |
| prepolymer | | | | | |
| polybutadiene + | 12.33 | 12.33 | 12.33 | 12.33 | 12.33 |
| BHT | | | | | |
| tri-functional | 4.53 | 1.87 | 2.51 | 2.99 | 3.63 |
| curative | | | | | |
| (POLYOL 3611) | | | | | |
| TIPA | 0.10 | 0.10 | 0.10 | 0.10 | 0.10 |
| FeCl₃ | 0.17 | 0.17 | 0.17 | 0.17 | 0.17 |
| LiN(SO₂CF₃)₂ | — | — | — | — | — |
| CsHFAc | 0.017 | — | — | — | — |
| tri-functional | — | 8.50 | 6.50 | 5.00 | 3.00 |
| curative | | | | | |
| (POLYOL 3165) | | | | | |

The polyurethanes included a 0.95 stoichiometric ratio of —OH to —NCO. The polycaprolactone/diisocyanate prepolymer (VIBRATHANE® 6060 available from Chemtura Corp.) and polybutadiene diol (POLY bd® R-45 HTLO with BHT available from Sartomer Company, Inc.) were independently warmed to 75° C. and degassed in a vacuum oven prior to mixing. The tri-functional curatives (Polyol 3611, Polyol 3165 available from Perstorp Polyols, Inc.) and triisopropanol amine (TIPA) were added to the formulation at ambient temperature immediately prior to molding. The first and second conductive additives including ferric chloride, LiN(SO₂CF₃)₂ (FLOURAD® HQ-115 available from 3M) and CsHFAc were added to the urethane as solutions in POLYOL 3611.

The mixture was cast into a “button” mold for material screening having a height of 12 mm and a diameter of 29 mm. Then the mixture was cured at 104° C. for a total of approximately 16 hours using a combination of curing in the mold, de-molding and post-curing. The samples were then baked in air at 100° C. for 10 to 12 hours to produce a resistive layer.

The buttons were then tested by a number of electrical techniques. The samples were prepared for electrical testing by applying a conductive media, such as conductive carbon paint, to the top and bottom of each button. Electrical contacts were then attached to the top and bottom of the buttons to create a circuit. For each button, the direct current resistivity of the roll at 100 volts, the time constant and the alternating current resistivity of the roll at 1 kHz were measured.

The time constant was measured by applying a 100 volt bias to the sample, removing the voltage, then measuring the time for the voltage on the button to decay to 1/e of its original value. The time constant relates to the resistivity (RHo_{c}) and thickness (T_{c}) of the oxidized surface layer on the sample. Surface layer resistivity (RHo_{c}), surface layer thickness (T_{c}) and bulk resistivity (RHo_{b}) were measured at 15.6° C. and 20% relative humidity. Acceptable levels of Rho_{c} are from 1×10¹⁰ to 1×10¹² Ohm-cm, T_{c} from about 30 to 250 microns and Rho_{b} less than about 1×10⁹ Ohm-cm.

In addition to the electrical properties, Shore A durometer and compression set of the buttons were measured as well. The Shore A durometer was measured according to ASTM Method D2240-86. The compression set was measured according to ASTM D395-89, method B, where the buttons were subject to 25% compression in height at 70° C. for 22 hours and the resultant permanent set was measured at room temperature. Acceptable compression set is 8% or less. The results of the electrical and physical property measurements are outlined in Table 2.

TABLE 2

| | Rho_{c} | T_{c} | Rho_{b} | Hardness | Compression |
|---|---|---|---|---|---|
| Example # | (Ohm-cm) | (μm) | (Ohm-cm) | (Shore A) | Set % |
| C | 1.66E+12 | 64 | 2.48E+08 | 55 | 1.58 |
| 1 | 6.49E+11 | 67 | 2.56E+08 | 55 | 1.81 |
| 2 | 7.73E+11 | 71 | 2.40E+08 | 54 | 1.98 |
| 3 | 1.36E+12 | 53 | 2.19E+08 | 55 | 1.80 |
| 4 | 7.68E+10 | 134 | 2.57E+08 | 55 | 1.53 |
| 5 | 9.14E+10 | 122 | 2.59E+08 | 54 | 1.28 |
| 6 | 2.75E+11 | 76 | 2.59E+08 | 55 | 1.43 |
| 7 | 3.76E+10 | 143 | 1.63E+08 | 54 | 2.88 |
| 8 | 5.02E+10 | 126 | 1.81E+08 | 54 | 1.35 |
| 9 | 1.89E+11 | 76 | 1.96E+08 | 56 | 2.02 |
| 10 | 2.25E+11 | 46 | 2.28E+08 | 56 | 1.23 |

The addition of the second additive to the above formulations 1-10, as compared to the control formulation C, appears to have decreased the resistivity of the surface layer Rho_{c} without interfering with the thickness of the surface layer formed (T_{c}), Shore A hardness or % compression set.

The foregoing description of several methods and embodiments of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. An image forming component comprising:
a urethane body, comprising polydiene containing a residual double bond available for oxidation, and including a surface, wherein said double bond is oxidized;
a first conductive additive including a transition metal salt, wherein said first conductive additive catalyzes the oxidation of the polydiene; and
a second conductive additive including an inert conductive additive that does not catalyze said polydiene oxidation, wherein said image forming component exhibits a surface layer resistivity in the range of 1.0×10⁹ to 1.0×10¹² ohm-cm, when characterized at 15.6° C. and 20% RH.

2. The image forming component of claim 1, wherein said first conductive additive is a metal halide.

3. The image forming component of claim 1, wherein said first conductive additive is selected from the group consisting of ferric chloride, ferrous chloride, ferric bromide and calcium chloride.

4. The image forming component of claim 1, wherein said second conductive additive is an alkali metal salt.

5. The image forming component of claim 1, wherein said second conductive additive is a quaternary ammonium salt.

6. The image forming component of claim 1, wherein said second conductive additive is non-ionic polyoxyalkylene polyol.

7. The image forming component of claim 1, wherein said component is a developer roll.

8. The image forming component of claim 1, wherein said component is in a printer.

9. The image forming component of claim 1, wherein said component is in a toner cartridge.

10. A method of making an image forming component comprising:
mixing a diisocyanate, a diol, a first conductive additive including a transition metal salt and a second conductive additive to form a mixture;
forming said mixture into a component having a surface; and
oxidizing said surface, wherein said first conductive metal salt catalyzes the oxidation of said diol and said second conductive additive is inert and does not catalyze the oxidation of said diol, to form an image forming component, wherein said image forming component exhibits a surface resistivity in the range of 1.0×10⁹ to 1.0×10¹² ohm-cm, when characterized at 15.6° C. and 20% RH.

11. The method of claim 10, wherein said diisocyanate comprises a diisocyanate prepolymer.

12. The method of claim 11, wherein said diisocyanate prepolymer includes a polyester moiety.

13. The method of claim 11, wherein said diisocyanate prepolymer includes a polycaprolactone moiety.

14. The method of claim 10, wherein said diol comprises a polydiene diol.

15. The method of claim 10, wherein said diol comprises a polybutadiene diol.

16. The method of claim 10, wherein said second conductive additive is a salt of an alkali metal.

17. The method of claim 10, wherein said second conductive additive is a quaternary ammonium salt.

18. The method of claim 10, wherein said second conductive additive is a non-ionic polyoxyalkylene polyol.

19. The method of claim 10, further comprising mixing a curative in said mixture, wherein said curative is at least di-functional.

20. The method of claim 10, further comprising mixing an antioxidant in said mixture.

21. The method of claim 10, wherein said mixture is formed by casting said mixture on a substrate.

22. The method of claim 10, further comprising curing said mixture at a temperature in the range of 50° C. to 150° C.

23. The method of claim 10, further comprising oxidizing said surface at a temperature of at least 80° C.
